(19) United States
(12) Patent Application Publication
(10) Pub. No.: US 2011/0209439 A1
(43) Pub. Date: Sep. 1, 2011

(54) BALE CUTTER

(76) Inventor: BRADLEY P. ACTIS, Clovis, CA (US)

(21) Appl. No.: 13/035,516

(22) Filed: Feb. 25, 2011

Related U.S. Application Data
(60) Provisional application No. 61/308,789, filed on Feb. 26, 2010.

(51) Int. Cl. B26D 1/03; B26D 3/24; B65B 5/00

(52) U.S. Cl. 53/111 R; 83/425.2; 83/13

(57) ABSTRACT

A bale cutter assembly and associated method for automatically cutting a bale of fibrous material to allow for the taking of a sample at a single point from one or two sides of the bale after the bale has been conveyed from the bale press with the bale retention straps in place. An elevator mechanism lifts the bale from a lower level to an upper level, while the plurality of cutter assemblies cut a section of the bale for obtaining the sample when the bale is being lifted between the lower level and the upper level.

### CROSS-REFERENCE TO RELATED APPLICATIONS

This application claims the benefit of U.S. provisional Application No. 61/308,789, filed Feb. 26, 2010, the contents of which are hereby incorporated by reference for all purposes.

### BACKGROUND

In order to evaluate the quality of certain fibrous materials, such as cotton, before sale, a sample of the material from each bale is provided to an evaluating agency, typically a division of the USDA. This evaluation called ‘grading’ allows a bale to be sold to customers without the entire product being seen. Further, before large quantities of the fibrous materials are stored for later sale, samples of the material may be obtained to be provided to perspective customers for testing, rather than transporting an entire bale to the perspective customer.

Conventional methods for obtaining a sample from every bale requires intense manual labor with workers having to physically tear one or more samples, typically two, of material from the same bale and insert them into a bag or sleeve. In certain applications, a cutter is used to pre-cut a sample during a bale pressing and forming process for later manual removal by a worker. Not only are workers prevented from completing other tasks while they are obtaining samples, but repeating the same motion for long periods of time may lead to chronic injuries. Further, manually obtaining the samples increases the likelihood that the resulting samples will be nonuniformly sized, will be contaminated by substances on the workers hands, and will be more costly due to the added labor expense.

### SUMMARY

The present disclosure provides a bale cutter assembly and associated method for automatically cutting a bale of fibrous material to allow for the taking of a sample at a single point from one or two sides of the bale. Generally, the bale is to be cut after the bale has been conveyed from the bale press with the bale retention straps in place.

In one aspect, a system for cutting a bale of fibrous material is provided which includes a transportation mechanism for moving a bale of fibrous material from a first position to a second position; and a plurality of cutter assemblies for creating at least one cut section on the bale as the bale is moved between the first position and the second position.

In another aspect, a system is provided for cutting a bale of fibrous material including an elevator mechanism for lifting a bale of fibrous material from a lower level to an upper level; and a plurality of cutter assemblies for creating a cut section of the bale for obtaining a sample from the bale when the bale is being lifted between the lower level and the upper level. At least one of the cutter assemblies includes a cutting blade.

In yet another aspect, a method is provided for cutting a bale of fibrous material. The method includes moving a bale from a pre-cut position to a post-cut position; moving a first cutter unit against a first side of the bale; and cutting a surface of the first side of the bale to create a cut section of the bale.

In yet another aspect, a method is provided for cutting a bale of fibrous material including moving a first cutter unit against a first side of a bale; and substantially simultaneously moving a second cutter unit against a second side of the bale to cause a pressing surface of the first and second cutter units to apply a controllable force against the bale as the bale is elevated from a first level below the first and second cutter units to a second level above the first level. The method also includes cutting a surface of either the first side or the second side of the bale to create a cut section of the bale as the bale is elevated from the first level to the second level.

Other aspects and variations of the bale cutter assembly summarized above are also contemplated and are more fully understood when considered with respect to the following disclosure.

### BRIEF DESCRIPTION OF THE DRAWINGS

FIG. 1A is a simplified perspective side view of a bale cutter assembly according to an embodiment of the present disclosure:

FIG. 1B is a simplified end view of the bale cutter assembly of FIG. 1A according to aspects of the present disclosure;

FIGS. 2A and 2B are a simplified perspective view and side view of cutter according to embodiments of the present disclosure;

FIG. 2C are simplified illustrations of various exemplary blade types for use in the present disclosure:

FIGS. 3A-3D are simplified end views of operational embodiments of the hale cutter assembly of FIG. 1A in accordance with embodiments of the present disclosure; and

FIGS. 4A and 4B are simplified illustration of a bale bagging system in which the bale cutter assembly may be incorporated according to an embodiment of the present disclosure.

### DETAILED DESCRIPTION

The detailed description set forth below in connection with the appended drawings is intended as a description of embodiments of the bale cutter assembly provided in accordance with aspects of the present disclosure and is not intended to represent the only forms in which the present disclosure may be constructed or used. The description sets forth the features and the steps for using the bale cutter assembly of the present disclosure in connection with the illustrated embodiments. It is to be understood, however, that the same or equivalent functions and structures may be accomplished by different embodiments that are also intended to be encompassed within the spirit and scope of the disclosure. As denoted elsewhere herein, like element numbers are intended to indicate like or similar elements or features.

Obtaining samples from bales before the bales are bagged or otherwise encased in a protective covering ensures that the integrity of such protective covering remains intact. A system for sampling a bale of fibrous material is disclosed in U.S. Publication No. 2009/0188332 A1, Ser. No. 12/360,025, the contents of which are expressly incorporated herein by reference, which was also previously incorporated by reference in provisional application No. 61/308,789. Generally, a sample is formed during the pressing process using a cutting protrusion, such as a blade or knife mounted on a support structure. This cutting protrusion is forced into the fibers, severing them from the cohesive, intertwined body of the bale. Since the sample will be removed, it is practical to cut the sample between the areas where bale retention straps are typically placed. The cut sample typically bulges from the side of the bale when the pressing force is removed since it is not bound to its neighboring fibers contained by bale retention straps.

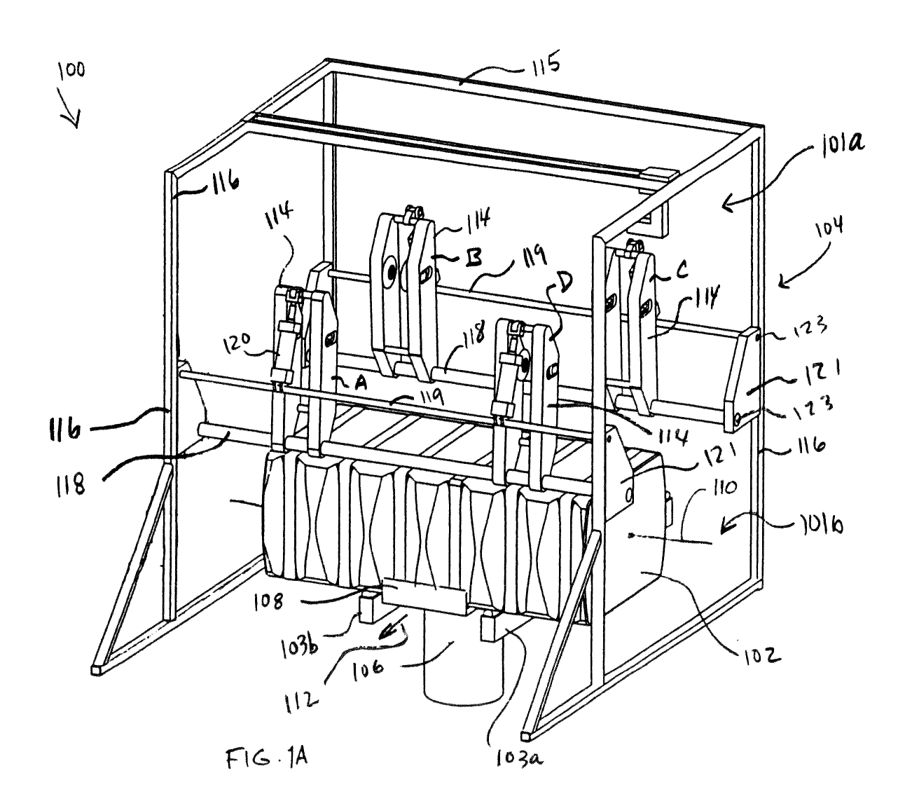

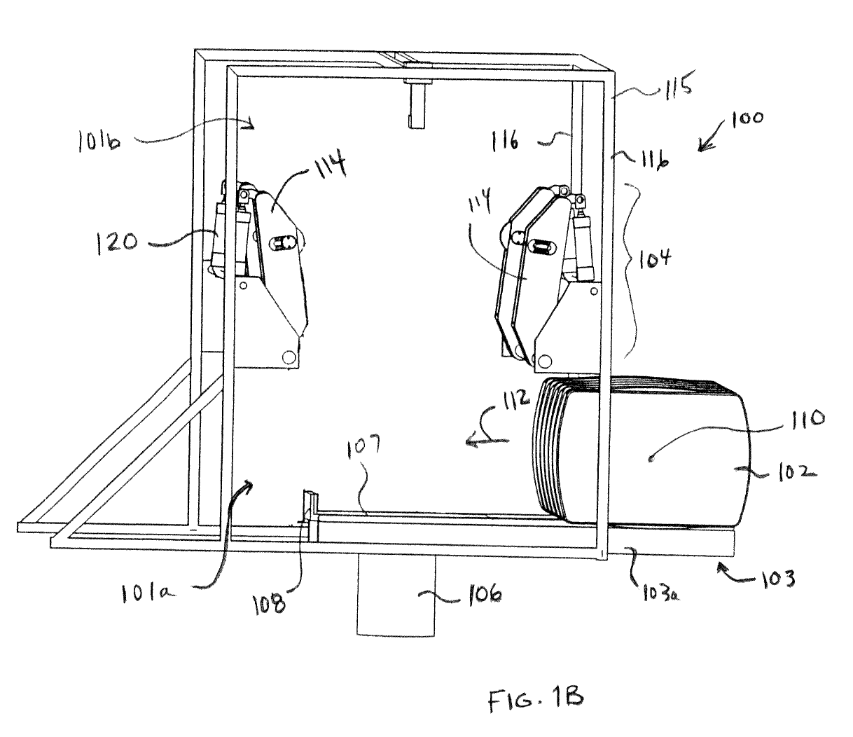

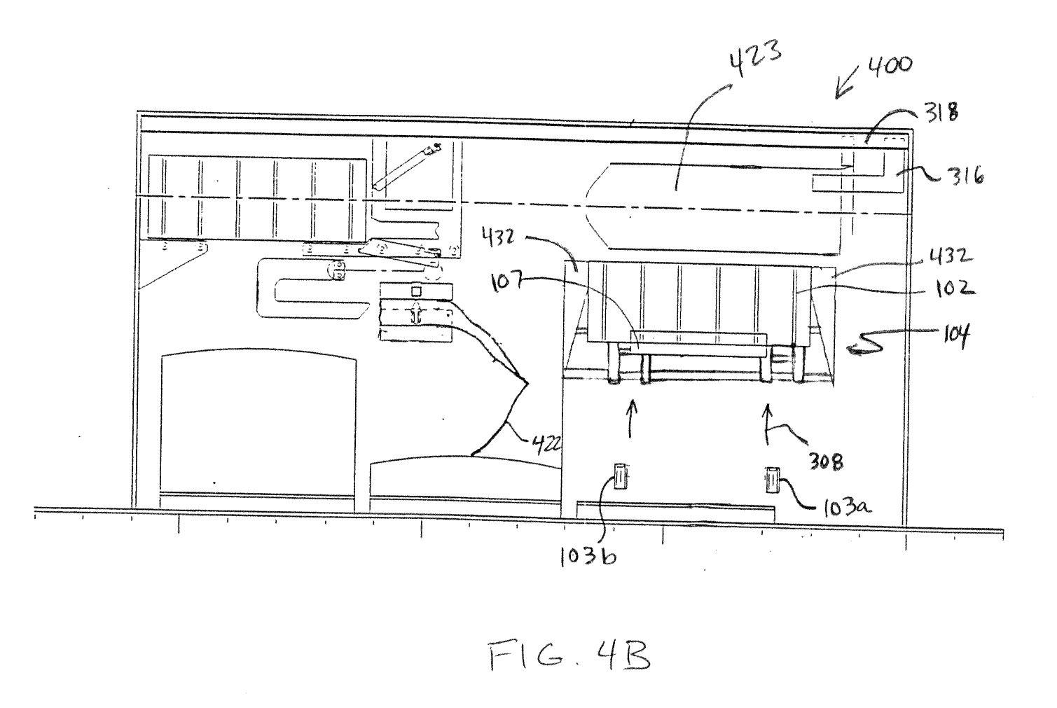

FIGS. 1A and 1B are a simplified perspective view and end view, respectively, of a bale cutter assembly 100 in accordance with exemplary embodiments of the present disclosure. The bale cutter assembly 100 may embody a stand-alone device for cutting and retrieving bale samples or may be incorporated into a larger system that transports the bale, cuts and samples the bale, and bags the bale. An exemplary bale bagging system is further discussed with reference to FIGS. 4A-4B. The bale cutter assembly 100 is provided to automatically “cut” a bale 102 at predetermined locations along the sides of the bale 102. The cut exposes a pre-cut section from which a sample may be taken. Since the bale is compressed and strapped during the cutting process, the fibrous material is under relatively high pressure. Accordingly, when cut, the tightly compressed fiber tends to protrude or bulge from the pre-cut sections, allowing the exposed protruding fiber to be grasped and separated from the bale 102. Generally, the bale 102 retains an “uncut” side across a top and bottom length of the bale.

As shown in FIGS. 1A and 1B, bale cutter assembly 100 generally includes an upper level 101a including cutting assembly 104 and a lower level 101b including an elevator mechanism 106. In one embodiment, a bale transport mechanism or conveyor 103 is used to deliver the bale 102 to the lower level 101a and position the bale 102 onto the elevator mechanism 106, adjacent and below the cutting assembly 104. In one embodiment, a conveyor 103 is incorporated to transport the strapped bale 102 to the cutting assembly 104. The conveyor 103 may include a set of rails 103a and 103b and a plurality of spaced rotatable cylinders (not shown) extending between rails 103a and 103h. The cylinders are configured such that a portion of each cylinder is substantially flush with or protrudes slightly above the rails, allowing bale 102 located on the conveyor 103 to be transported in the direction of rotation of the cylinders. One of ordinary skill in the art will appreciate that the conveyor 103 may also be in the form of a conveyor belt driven by a rotatable source, such as a motor or a drive train, a table with an external pushing arm, or other appropriate configuration to transport the bale 102. The conveyor 103 may also be operationally coupled to other transport mechanisms, conveyors and any other material handling means for transporting the bale 102 to the lower level 101b.

In one embodiment, the terminating ends of rails 103a and 103b extend from an end of the conveyor 103 in a cantilevered arrangement absent of the cylinders, belt driver or the like. A space is maintained between the cantilevered portions of the rails 103a and 103b large enough to allow for a platform 107 of elevator mechanism 106 to be positioned between the cantilevered rails. The platform 107 is configured and sized to receive the bale 102 thereon and to be raised, as further discussed below. The elevator mechanism 106 also includes a bumper stop 108. The bumper stop 108 is provided to impede the momentum of the bale 102 as it moves from the conveyor 103 onto the platform 107. Once the bale has reached the bumper stop 108, the bale 102 is fully seated on the platform 107 and is ready for further processing as described below.

In one embodiment, the elevator mechanism 106 may be any conventional lifting mechanism, for example, a scissor lift mechanism with a support surface may be used to raise and lower the bales. As one of ordinary skill in the art will appreciate, a hydraulic, pneumatic, or electro-mechanical cylinder or motor with a belt/chain may also be used to raise or lower the support platform 107, which may move vertically along rails, guides, tracks, or other suitable transportation means, if needed.

With further reference to FIGS. 1A and 1B, the cutting assembly 104 comprises a plurality of cutter units 114 each supported on a frame 115. In one embodiment, the frame 115 comprises two vertical, rectangular shaped end frames 116 connected together using horizontally extending support members 118 and 119 to form a generally box-like configuration. The two support members 118 and 119 extend parallel to one another and are supported by flanges or support brackets 121 mounted on the end frames 116. In one embodiment, the flanges 121 may include bushings, bearings or bearing surfaces 123 configured to receive the support members 118 and 119, which allow both support members 118 and 119 to rotate, if desired. One of ordinary skill in the art will understand that the vertical and horizontal distances between the support members 118 and 119, the size, shape and physical properties of each support member are collectively a function of the size, weight and other variable design features of the cutter unit to be mounted thereon. The frame 115 and the support members 118 and 119 may be made from metal, plastic, steel bars or steel beams. As will be appreciated by one of ordinary skill in the art, the frame 115 may have various configurations while remaining within the scope and spirit of the present disclosure. In a particular embodiment, the frame is simply the housing of a bagger system, such as the one disclosed with reference to FIGS. 4A-4B, further discussed below.

As further described in detail below, each of the plurality of cutter units 114 is mounted at one end at a predetermined position along the lower horizontal support member 118 with the operational or cutting portion of each cutter unit 114 facing inward or toward the center of frame 115. At the other end, the cutter units 114 are each mounted to the upper horizontal support member 119 via an actuation device 120, such as a hydraulic piston, an air cylinder, a mechanical drive or a similar mechanism, located at a corresponding predetermined position. Actuation device 120 creates the “cutting” or “pressing” force for each cutter unit 114 to operate in accordance with the present disclosure, as described below.

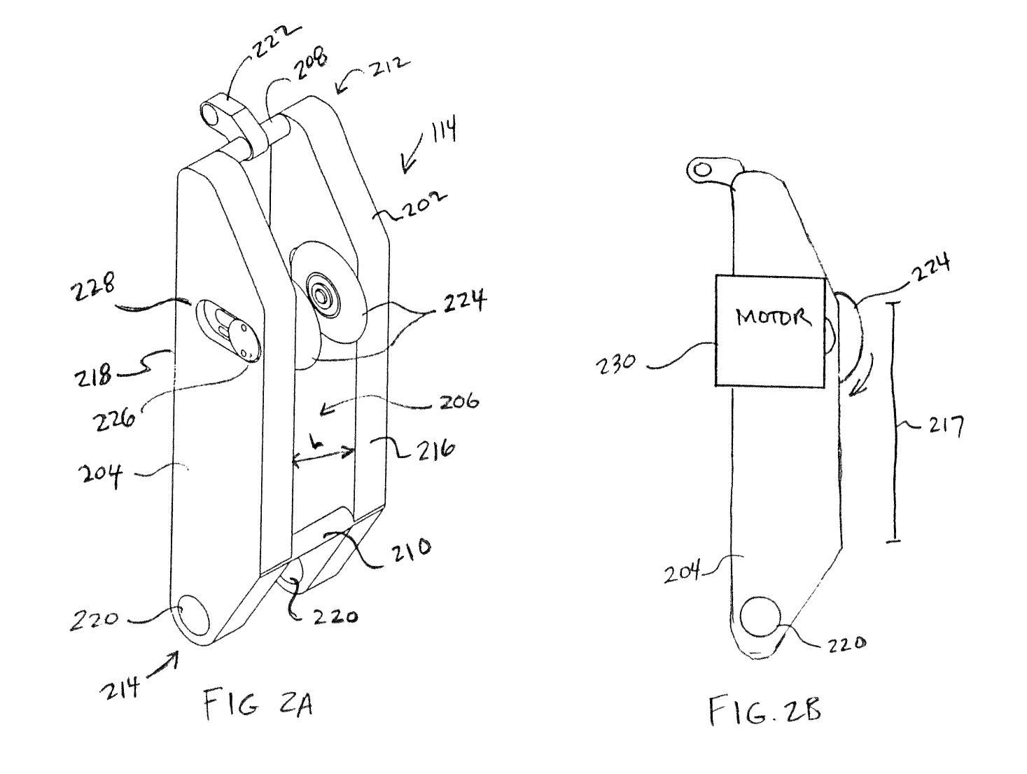

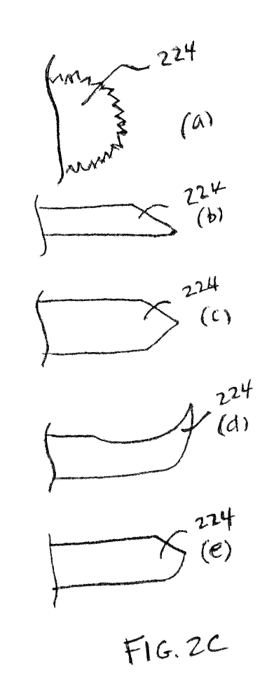

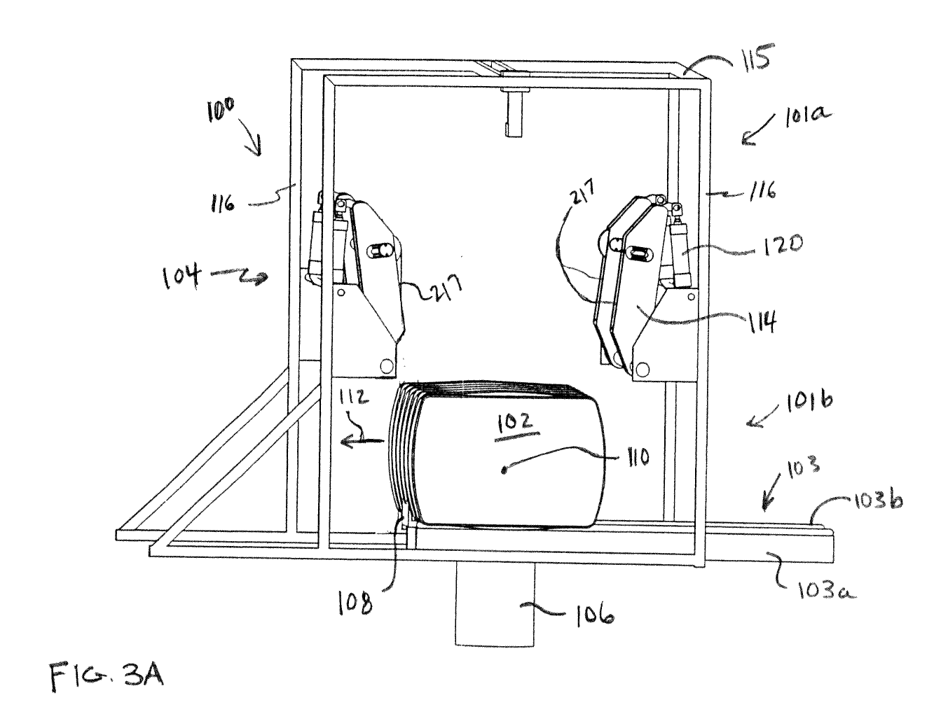

FIG. 2A is a simplified perspective view of the cutter unit 114 according to one embodiment of the present disclosure. In one embodiment, the cutter unit 114 comprises a first block 202 connected to a second block 204 in a parallel and spaced apart relationship relative to one another using cross members 208 and 210. Cross members 208 and 210 are designed to couple first and second blocks 202 and 204 together and to maintain a space or gap 206 therebetween, having a length L. It should be understood that the length L of the space 206 corresponds to the length of the sample to be cut and may be varied as desired by varying length of the cross members 208 and 210. Each block 202 and 204 may be similarly shaped and in one embodiment includes a top end 212, a bottom end 214, a front face 216 and a rear face 218. Front face 216 includes a pressing surface 217 (see FIG. 2B) that allows the cutting/pressing force being applied by the cutter unit to be distributed against a commensurate area on the bale 102. As will be appreciated by one of ordinary skill in the art, first and second blocks 202 and 204 may have various configurations and shapes, which maintain the pressing surface 217 while remaining within the scope and spirit of the present disclosure. In other embodiments, the cutting block 114 is rotated beyond vertical such that only the cutting blades make contact with the bale and not the front face.

In one embodiment, holes 220 are defined at each bottom end 214 of the blocks that are sized and configured to receive the support member 118 therethrough to mount the cutter unit 114 to the frame 115 (see FIG. 1A). The cross member 208 at top end 212 may include a coupling device 222 to couple the top end 212 to the actuation device 120 (FIG. 1A). As shown, the coupling device 222 comprises an opening 223 for accommodating a rod or shaft for use by the actuation device to pivot the cutter unit.

When activated, the actuation device 120 causes the top end 212 to rotate towards the internal center of the frame 115, and the bottom end 214 to pivot about the horizontal support member 118 to which it is attached. This may be accomplished by allowing the support member 118 to rotate within the holes 220 or else by allowing the support member 118 to rotate on bearing surface 123 on the flange 121 (FIG. 1A). In this manner, a controllable cutting/pressing force can be used to press each cutter unit 114 against any object, such as the bale 102, positioned adjacent the pressing surface 217. Each cutter unit 114 may be rotated simultaneously, or alternatively, each cutter unit 114 may be rotated individually.

Each cutter unit 114 may also include a plurality of cutting blades 224 with at least one cutting blade 224 positioned on each block 202 and 204. The cutting blades 224 are configured to be forced into the fibers, severing them from the cohesive, intertwined body of the bale 102. Each cutting blade 224 is mounted at a location directly adjacent a corresponding cutting blade positioned on the opposing block. However, in a preferred embodiment, only two of the four cutting units are equipped with blades while the other two units merely provide an opposing force to prevent tilting or turning the bale during cutting, as further discussed below. Because blocks 202 and 204 are separated by the length L of space 206, the cutting blades 224 mounted thereto are also separated by the same length. This length L defines the width of the cut. The cutting blades 224 are configured such that a portion of each blade extends, protrudes or is extendible beyond the pressing surface 217, allowing the cutting blade 224 to contact any object that is made to contact the pressing surface 217, such as the bale 102. In one embodiment, each cutting blade 224 may include a mounting member 226 that is configured to be slidably mounted within a slot 228 defined at a predetermined position on the two blocks 202 and 204. The length of the slot 228 is formed perpendicular to the front face 216 of each block, thus, as the mounting member 226 is moved toward the end of the slot 228 closest to the front face 216, the cutting blade 224 is in a fully extended position. Conversely, as the mounting member 226 is moved toward the end of the slot 228 closest to the rear face 218, the cutting blade 224 is in a fully retracted position. One of ordinary skill in the art will appreciate that by sliding the mounting member 226 within the slot 228, the depth of each cut rendered by the cutting blades 224 may be adjusted. In one embodiment, the cutting blades 224 may be circular or rotating blades that can be made to roll across the surface to be cut. The mounting members 226 may traverse within the slots by an actuating air cylinder. Alternatively, the blades may be held stationary (i.e., not rotated and/or not translated within the slots) and the cutting motion on the bale is provided by the elevator mechanism as it raises the bale. In one embodiment, as shown in FIG. 2B, the blades 224 may be rotated by a drive mechanism 230. The drive mechanism 230 may be any known type of drive system, for example, a motorized gear system, a motorized pulley/chain drive system and the like.

It should be understood however that the cutting blades 224 may be any suitable blade, of any suitable geometry that concentrates all or most of the force onto a very small area, resulting in a high amount of pressure, which allows the blade to penetrate the fiber material. FIG. 2C shows a sample of some blade shapes 224(a)-(e) for use with the present disclosure, such as a standard knife blade, a fixed knife blade, a circular knife with serrated edges and the like. In one embodiment, the drive mechanism 230 of FIG. 2B, may be configured to move cutting blades 224(b)-(e) in a sawing motion so as to facilitate the cutting action. Cutting blades 224(b)-(e) may also include serrated teeth to facilitate sawing in addition to cutting.

Referring again to FIG. 1A, in one embodiment, each of the plurality of cutter units 114 may operate as either a blade unit, which means the cutter unit has an extended blade, or a back pressure unit, which means the cutter unit has no blade or is operating with a fully retracted blade. In one embodiment, each blade unit is positioned on an opposite side of the frame 115 from a corresponding back pressure unit. The back pressure unit provides a reaction or pressing force to counter the cutting force applied by the corresponding and oppositely positioned blade unit. For example, as shown in FIG. 1A, four cutter units 114 are provided. In this example, cutting assembly A is positioned opposite from and facing cutting assembly B. Similarly, cutting assembly C is positioned opposite from and facing cutting assembly D. Cutting assemblies B and D are blade units and cutting assemblies A and C are back pressure units (i.e. no blade or fully retracted blade). In this arrangement, as cutting assemblies B and D are made to rotate toward an object to be cut, cutting assemblies A and C provide the back pressure such that an equal amount of cutting force and pressing force is applied to both sides of the bale 102 by the actuation device 120 to avoid the creation of torque on, or misalignment of, the bale 102.

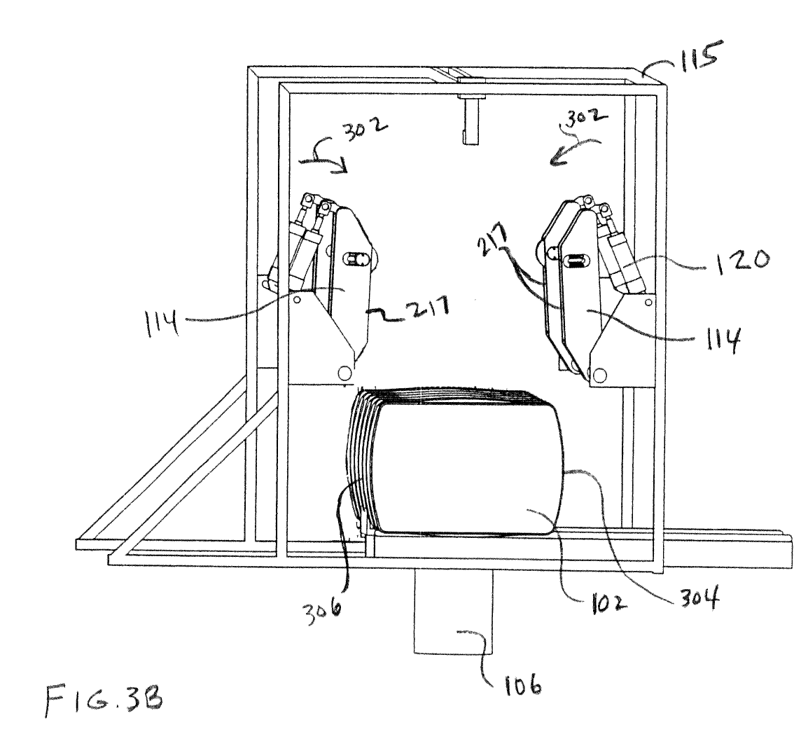

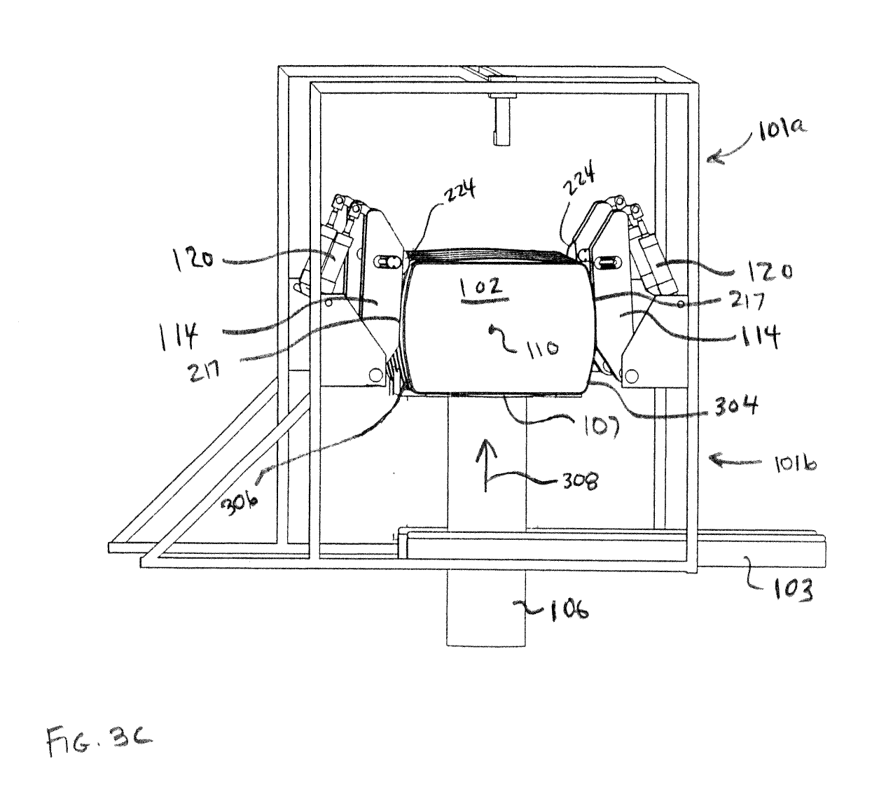

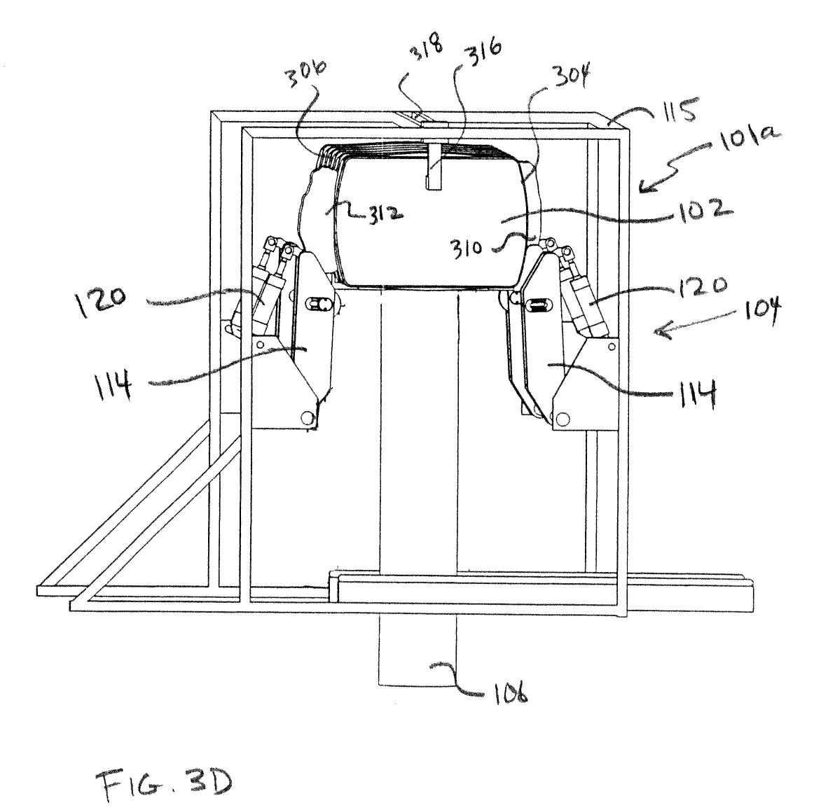

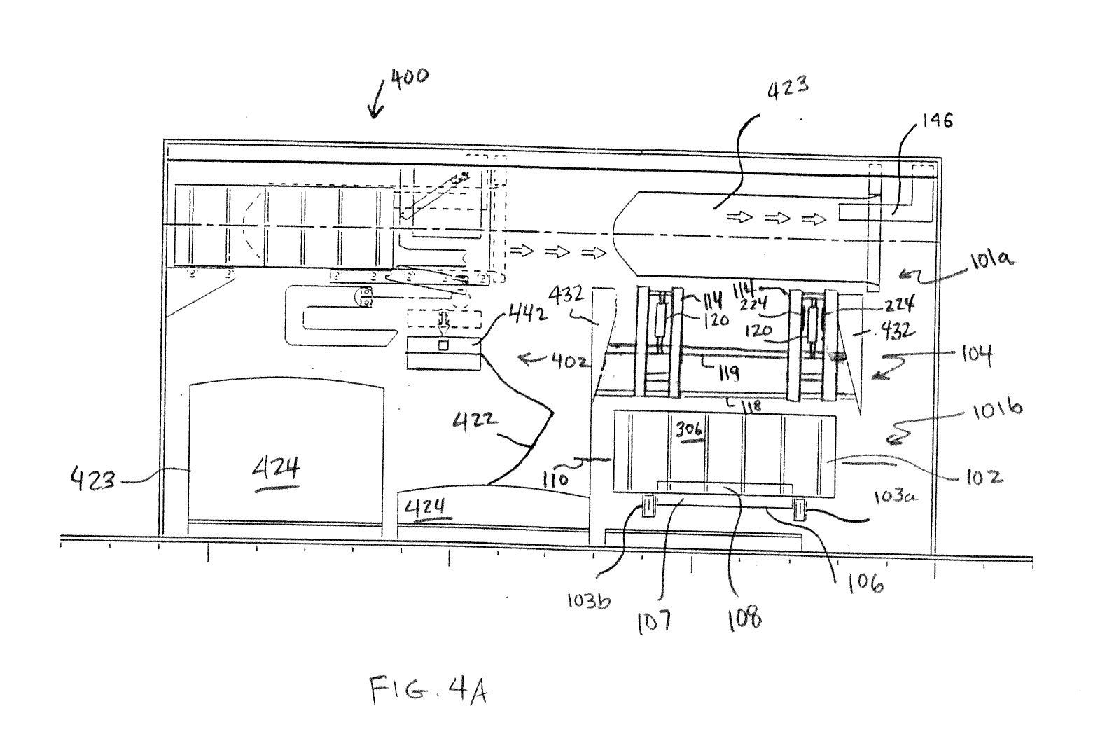

FIGS. 3A-3D are simplified end views showing the operation of cutting a bale to provide access to a sample of fiber material from the bale in accordance with an embodiment of the disclosure. As shown in FIG. 3A, a strapped hale 102 is delivered via rails 103a and 103b of the conveyor 103 to lower level 101b of the cutting assembly 104. The bale 102 that has been readied for sampling is delivered with the longitudinal axis 110 (long side) of the bale 102 positioned perpendicularly to the direction of travel 112. The bale 102 traverses the conveyor 103 until the bale 102 reaches the bumper stop 108 positioned at the end of the rails. The bumper stop 108 impedes the movement of the bale, stopping the bale 102 on platform 107 of the elevator mechanism 106, such that the longitudinal axis 110 of the bale 102 becomes aligned operationally with the cutting assembly 104.

As shown in FIG. 3B, once the bale 102 is properly seated on the platform 107 of the elevator mechanism 106, the actuation devices 120 are activated. The actuation devices 120 cause the cutter units 114 to pivot toward the longitudinal axis 110 (centerline) of the bale 102 (arrow 302). In this manner, the pressing surfaces 217 may be made to come into slidable contact with a first side 304 and a second side 306 of the bale 102 as the bale traverses past the cutter units as described below.

As shown in FIG. 3C, the elevator mechanism 106 operates to lift the bale 102 into upper level 101a (arrow 308). As the bale 102 is lifted, the first side 304 and the second side 306 are made to contact the pressing surfaces 217 of the cutter units 114. The actuation devices 120 maintain the cutting/pressing force of each cutter unit 114 as the bale 102 is lifted, thus, causing a “squeezing” pressure to be applied to the bale 102. The pressure applied by the cutter units 114 further centers bale 102.

As shown in FIG. 3D, as the bale 102 continues to be lifted through cutting assembly 104, the cutting blades 224 on the cutting units cut the first side 304 and the second side 306. The cuts create a cut section 310 on the first side 304 from which a sample may be taken and a cut section 312 on the second side 306 from which a sample may be taken. Since the bale 102 is compressed and strapped, the fibrous material is under relatively high pressure. As such, the cut sections 310 and 312 tend to protrude or bulge from the first and the second sides 304 and 306, respectively, allowing them to be grasped and separated from the bale 102. The amount of sample fiber that ultimately protrudes from the bale 102 is determined by the adjustment of the cutting unit blade.

A pusher mechanism 316 is configured to run within a track 318 disposed along the top of the frame 115. When the bale 102 with the cut sections 310 and 312 is lifted to the full extent of the elevator mechanism 106, the pusher mechanism 316 is activated to push the bale 102 from the raised platform 107 to a waiting conveyor (not shown) to be transported away from the bale cutter assembly 100 for further processing.

To facilitate an understanding of the embodiments of the bale cutter assembly 100 and associated method of the present disclosure, it should be understood that, in one embodiment, the bale cutter assembly 100 is intended to operate within the general architecture and operation of a bale sampler, such as the bale sampler disclosed and described in Ser. No. 61/023,812, previously incorporated herein. The bale sampler obtains and packages samples of a fibrous substance from a bale. More specifically, hale sampler may automatically obtain a sufficiently and relatively uniformly sized sample from both sides of a bale at nearly any location along the bale and, if desired, insert the two samples into a bag or two separate bags.

In yet another embodiment, the bale cutter assembly 100 may be incorporated into, and is intended to operate within the general architecture and operation of a bale bagging system, such as the bale bagging system disclosed and described in U.S. Provisional Application Ser. No. 61/033,376, filed Mar. 3, 2008, the contents of which are explicitly incorporated herein by reference for all purposes.

FIGS. 4A and 4B are simplified illustrations of a bale bagging system 400, similar to that described in Application Ser. No. 61/033,376, in which the bale cutter assembly 100 may be incorporated according to an embodiment of the present disclosure. As shown in FIG. 4A, the bale bagging system 400 comprises a first and a second bag bin 421, 423 configured for holding a bag stack 424 of a plurality of bags 422 to be supplied to hag retrieval assembly 402. Bale bagging system 400 includes a moveable bag retriever 442 comprising a head adapted to be attached to a portion of the bag 422. In an initial position, the hag retriever is located above the first bag bin 421 and configured to be lowered onto the bag stack 424 to retrieve the bag 422 on top of the stack. When the bag retriever 442 encounters the top bag 422, a bag attachment mechanism on the bag retriever secures the bag to a bottom surface of the bag retriever. Once the bag 422 has been secured to the bag retriever 442, the bag retriever retreats up to its initial position, thereby lifting the bag from the bag stack 424.

In one exemplary embodiment, a cutting assembly 104 is incorporated into bale bagging system 400 to cut a bale 102 as the bale is raised by elevator mechanism 106 into the bagging chute 423. For clarity, the side view shown in FIG. 4A shows only a background portion of the cutting assembly 104. As shown in FIG. 4A, the strapped bale 102 is delivered via the rails 103a and 103b of the conveyor 103 to the lower level 101b of the cutting assembly 104. The bale 102 traverses the conveyor 103 until the bale 102 reaches the bumper stop 108 positioned at the end of the rails and is seated on the platform 107 of the elevator mechanism 106. The actuation devices 120 are activated to cause the cutter units 114 to pivot toward the longitudinal axis 110 (centerline) of the bale 102. In this manner, the plurality of pressing surfaces 217 are made to come into slidable contact with the first side 304 and the second side 306 of the bale 102 as the bale 102 traverses past the cutter units.

As shown in FIG. 4B, the elevator mechanism 106 operates to lift the bale 102 into upper level 101a (arrow 308). As the bale 102 is lifted, the first side 304 and the second side 306 are made to contact with the pressing surfaces 217 of the cutter units 114. As the bale 102 continues to be lifted through the cutting assembly 104, the cutting blades 224 on the cutting units cut the first side 304 and the second side 306.

The pusher mechanism 316 is configured to run within the track 318 disposed along the top of the system. When the bale 102 is lifted to the full extent of the elevator mechanism 106, the pusher mechanism 316 is activated to push the bale 102 from the platform 107 to the chute 423 to be transported away from bale cutter assembly 100 for further processing. In an alternative embodiment, once the bale is raised to the appropriate height, it is simply pushed off by the pusher assembly 146.

Although embodiments of the cutting assembly have been specifically described and illustrated, many modifications, combinations, and variations of the embodiments will be apparent to those skilled in the art. Accordingly, it is to be understood that the illustrated embodiments have been set forth only for the purposes of examples, and that the embodiments should not be taken as limiting the disclosure as defined by the following claims. The following claims are, therefore, to be read to include not only the combination of elements which are literally set forth, but all equivalent elements for performing substantially the same function in substantially the same way to obtain substantially the same result. The claims are thus to be understood to include those that have been illustrated and described above, those that are conceptually equivalent, and those that incorporate the ideas of the present disclosure.

What is claimed is:

1. A system for cutting a bale of fibrous material comprising:
a transportation mechanism for moving a bale of fibrous material from a first position to a second position; and
a plurality of cutter assemblies for creating at least one cut section on the bale as the bale is moved between the first position and the second position.

2. The system of claim 1, wherein the transportation mechanism comprises an elevator mechanism, including a platform configured to receive the bale thereon, for lifting the bale between the first position and the second position.

3. The system of claim 1, wherein at least one of the plurality of cutter assemblies comprises at least one cutting blade.

4. The system of claim 3, wherein the cutting blade is moveable between an extended position and a retracted position.

5. The system of claim 3, wherein the at least one of the plurality of cutter assemblies comprises a drive mechanism for actuating the at least one cutting blade.

6. The system of claim 1, wherein the plurality of cutter assemblies comprise a cutter unit, and an actuation device, wherein the actuation device applies a force to the cutter unit to cause the cutter unit to press against the bale as the bale moves between the first position and the second position.

7. A system for cutting a bale of fibrous material comprising:
an elevator mechanism for lifting a bale of fibrous material from a lower level to an upper level; and
a plurality of cutter assemblies for creating a cut section of the bale for obtaining a sample from the bale when the bale is being lifted between the lower level and the upper level; at least one of the cutter assemblies including a cutting blade.

8. The system of claim 7, further comprising a pusher mechanism for removing the bale having the cut section from the elevator mechanism.

9. The system of claim 7, wherein the plurality of cutter assemblies comprises:
a first cutter unit having a first pressing surface, wherein the cutting blade extends beyond the first pressing surface, the first cutter unit positioned to allow the first pressing surface to contact a first side of the bale when the bale is being lifted between the lower level and the upper level; and
a second cutter unit having a second pressing surface, and having no cutting blade extend beyond the second pressing surface, the second cutter unit positioned to allow the second pressing surface to contact a second side of the bale when the bale is being lifted between the lower level and the upper level.

10. The system of claim 7, wherein the elevator mechanism comprises a platform configured to receive the bale thereon, for lifting the bale between the lower level and the upper level.

11. The system of claim 7, wherein at least one of the plurality of cutter assemblies comprises at least one cutting blade.

12. The system of claim 11, wherein the cutting blade is moveable between an extended position and a retracted position.

13. The system of claim 11, wherein the at least one of the plurality of cutter assemblies comprises a drive mechanism for actuating the at least one cutting blade.

14. The system of claim 7, wherein each of the plurality of cutter assemblies comprise a cutter unit, and an actuation device, wherein the actuation device causes the cutter unit to press against the bale as the bale moves between the lower level and the upper level.

15. A method for cutting a bale of fibrous material comprising:
moving a bale from a pre-cut position to a post-cut position;
moving a first cutter unit against a first side of the bale; and
cutting a surface of the first side of the bale to create a cut section of the bale.

16. The method of claim 15, wherein moving the bale from the pre-cut position to the post-cut position comprises:
elevating the bale from a first level below the first cutter unit to a second level above the first level.

17. The method of claim 15, wherein the first cutter unit comprises a pressing surface and a cutting blade, and wherein moving first cutter unit against the bale comprises:
activating an actuation device to cause the pressing surface to move towards the bale to cause the pressing surface to apply a controllable pressing force against the bale as the bale moves from the pre-cut position to the post-cut position.

18. The method of claim 15, wherein the first cutter unit comprises a pressing surface and a cutting blade, and wherein cutting the surface of the bale to create the cut section of the bale comprises:
activating an actuation device to cause the pressing surface to move towards the bale to cause the pressing surface to apply a controllable cutting force against the bale and cause the cutting blade to cut the surface of the first side of the bale to create the cut section of the bale as the bale moves from the pre-cut position to the post-cut position.

19. The method of claim 18, further comprising:
moving a second cutter unit against a second side of the bale to cause a pressing surface on the second cutter unit to apply a controllable pressing force against the second side of the bale as the bale moves from the pre-cut position to the post-cut position.

20. A method for cutting a bale of fibrous material comprising:
moving a first cutter unit against a first side of a bale; and substantially simultaneously moving a second cutter unit against a second side of the bale to cause a pressing surface of the first and second cutter units to apply a controllable force against the bale as the bale is elevated from a first level below the first and second cutter units to a second level above the first level; and
cutting a surface of either the first side or the second side of the bale to create a cut section of the bale as the bale is elevated from the first level to the second level.

21. A bale bagging assembly comprising:
a bale receiving section comprising an elevator mechanism for lifting a bale from a first position to a second higher position;
a cutter assembly for cutting a section of a bale as the bale transitions from the first position and the second higher position;
a bag retrieval assembly for retrieving a bag to place over a bale; and
a pusher assembly for pushing a bale into a bag.
